(19) United States
(12) Patent Application Publication
(10) Pub. No.: US 2026/0155995 A1
(43) Pub. Date: Jun. 4, 2026

(54) CONFIDENTIAL ELECTRONIC DOCUMENT SIGNATURE METHOD WITHIN AN ELECTRONIC SIGNATURE SERVICE FRAMEWORK

(71) Applicant: IGNISIGN, Luxembourg (LU)

(72) Inventors: Julien JENOUDET, Luxembourg (LU); Paul-Claude CAYON, METZ (FR)

(73) Assignee: IGNISIGN, Luxembourg (LU)

(21) Appl. No.: 19/219,110

(22) Filed: May 27, 2025

(30) Foreign Application Priority Data
May 27, 2024 (EP) 24178294.5

(51) Int. Cl. H04L 9/32

(52) U.S. Cl. CPC H04L 9/3247; H04L 9/3236

(57) ABSTRACT

A method for electronically signing a document while preserving the document's confidentiality from the electronic signature service. The method includes: receiving, by the service, a cryptographic hash of the document to be signed; initializing a signature session within a signature interface embedded in an operating application on a signature terminal controlled by the approver; transmitting the document only locally to the interface without disclosure to the service; computing a second hash value of the locally retrieved document; verifying that the received hash matches the computed hash; and, upon confirmation, enabling the approver to authorize the document for signature. The interface is executed under control of the operating application but supervised by the signature service, ensuring legal compliance while maintaining document confidentiality.

### TECHNICAL FIELD

The present invention pertains to the field of electronic signatures for electronic documents, and more particularly to a method of electronically signing an electronic document while ensuring the confidentiality of the document with respect to the providers of the electronic signature service.

### BACKGROUND

The invention relates to the field of electronic signatures and associated technologies. Electronic signatures are closely linked to digital cryptography technologies, particularly asymmetric cryptography, which relies on the principle of cryptographic key pairs. In the electronic signature process, the private key of an asymmetric key pair is used to digitally sign data according to well-established and recognized methods in the field. The public key of the pair enables verification that the electronic signature was performed with the corresponding private key. This mechanism ensures the confidentiality of the private key while allowing any entity possessing the public key to confirm the authenticity of the electronic signature made with the private key.

A technology frequently associated with electronic document signatures is that of electronic certificates, which link an electronic signature to a trusted source. Hierarchical structures between certification authorities and certificates issued to end users are well-established concepts recognized by experts in the field. The principles of Public Key Infrastructure (PKI) and implementations of electronic certificate technologies, such as the X.509 standard, rely on a chain of trust. This chain ensures the verification and validation of the legitimacy of electronic certificates.

The combined use of electronic signatures and electronic certificates facilitates the identification of the origin of data or certifies its approval by a specific entity. This entity, referenced in the electronic certificate issued to the end user, is associated with the asymmetric cryptographic key pair used to electronically sign data.

Three practical applications currently dominate the computing ecosystem: SSL certificates, blockchain technologies, and electronic document signatures.

Electronic document signatures, a specific branch of electronic signatures, enable individuals or legal entities (and their direct or indirect representatives) to confirm the origin of a document or express their approval thereof.

The primary objective of electronic document signatures is to ensure the reliability of a document while enabling its transmission in electronic form. This procedure will hereinafter be referred to as “electronic document signature.”

To perform an electronic document signature while preserving the legal validity of the signature, it is critical to follow a series of defined steps within a “global signature process.”

This field is governed by numerous state-of-the-art standards, such as eIDAS in the European Union or the ESIGN Act in the United States.

In the context of the global signature process and generally within the scope of the present invention, the term “signature service” refers to the provider responsible for ensuring the proper execution of the global signature process. This provider offers a range of services through an infrastructure comprising hardware, software, and human resources, designed to align the global signature process with the aforementioned state-of-the-art standards. The infrastructure ideally includes a set of software applications and one or more computer servers capable of meeting the logical and technical requirements of the process while complying with state-of-the-art standards.

In the context of the global signature process and generally within the scope of the present invention, the term “document to be signed” refers to any digitally encoded data, such as an image, audio recording, text document, or structured data from a computing process. Advantageously, this document is accompanied by metadata to facilitate its discovery, use, and/or storage. This data may be modified until the commencement of the technical signature phase of the document, which is detailed later in this document.

In the context of the global signature process and generally within the scope of the present invention, the term “signatory” refers to the individual or legal entity that certifies the origin of or expresses approval of the document to be signed.

### DESCRIPTION OF A GLOBAL DOCUMENT SIGNATURE PROCESS

To meet the requirements of state-of-the-art standards and maintain the chain of trust and probative value of the electronic signature, the following phases must at minimum be performed:
Initialization phase of the signature request: This phase allows the originator of the signature to send a signature request to the approvers of the signature. The originator may be the signatory themselves, another individual, a legal entity acting through one of its representatives, or an automated computing system. The document to be signed, or a derived or partial version thereof, may optionally be provided at this stage. If a document is provided during this phase, the signature service is responsible for verifying that: 1) the document presented during the signature session corresponds to the document the originator initially intended to submit for signature, and 2) the approver ultimately approves the document they have viewed. The responsibility for ensuring the proper execution of this phase lies with the signature service.
Optionally, an identification phase of an approver: This phase ensures the identity of the signatory and, in the case of a signature on behalf of a legal entity, their legitimacy to represent said entity. This phase may optionally associate the subject of an end-user electronic certificate with an asymmetric cryptographic key pair.

In the context of the global signature process, the term “approver” refers to the individual or computing device that expresses approval to sign the document and verifies the document's compliance on behalf of the signatory. The approver and the signatory may be the same or different.

Possession of the private key of the key pair may be maintained under the responsibility of the signatory (referred to as “signature performed under the signatory's responsibility”) or delegated to a trusted authority that performs the operational signature on behalf of the certificate subject. This delegation is subject to strict operational constraints, requiring compliance with the aforementioned state-of-the-art standards. Depending on the mode of private key possession, the mechanisms for the “technical document signature” will differ.

In all cases, this identification phase allows the signature service to collect information that can be included in the signature evidence to enhance its probative value. The responsibility for ensuring the proper execution of this phase lies with the signature service.

The identification phase is not ordered relative to the initialization phase and may be performed before or after it. The identification phase may also optionally be included in the signature session phase described later in this document.
Signature session phase (or signature ceremony): This phase aims to obtain the approver's consent to certify the origin of or express approval of the document to be signed. The responsibility for ensuring the proper execution of this phase lies with the signature service.

During the signature session, several key steps are necessary to confer legitimacy to the signature:
Identification or authentication step of the signatory: This step verifies the signatory's identity to ensure they are authorized to sign the document. This step may also be performed outside the signature session phase (see above).
Document review step: In accordance with state-of-the-art standards, it is imperative that the approver has the opportunity to review the document before signing it. This step ensures the signatory is fully informed of the document's content they are about to approve.
Formal recording of the signatory's intent: This step involves explicitly documenting the signatory's agreement to certify the origin of or express approval of the document to be signed.
Technical document signature phase: Following a successful signature session, this phase involves performing a cryptographic signature. This process securely associates the document to be signed with an asymmetric cryptographic key pair and, by transitivity, with an electronic certificate. To optimize this step, it is recommended not to sign the document itself directly but rather a digital fingerprint or cryptographic hash value of the document. This method enhances the security of the signature while ensuring the document's integrity.

In the context of the global signature process and generally within the scope of the present invention, the term “cryptographic hash value” refers to a deterministic cryptographic function that generates a fixed-length, unique digital fingerprint from source data. This fingerprint is designed to be collision-resistant, meaning that two different source data sets should not produce the same fingerprint. A fundamental characteristic of this cryptographic hash value is that it is designed to be one-way, making the operation irreversible. Notable algorithms for creating such cryptographic hash values include SHA-256 and SHA-512.

Upon successful completion of the technical document signature phase, the signature evidence generation phase may proceed. This phase involves encapsulating the technical signature within a digitally encoded element that enables subsequent verification of the signature's validity. To enhance the probative value of the signature, it is common to include various additional elements in this signature evidence.

Formats that may be used to encode this evidence include, but are not limited to, XaDES, PaDES, CaDES, ASIC-E, W3C Verifiable Credentials, and C2PA. In the context of the global signature process and generally for this invention, these formats are referred to as “standardized signature evidence formats.”

The “signature evidence,” as defined in the context of this invention, refers to the files generated during the signature evidence creation phase. These signature evidence files are structured, digitally encoded data, primarily based on the standardized signature evidence formats mentioned above. However, they may be adapted or derived from these standard formats by adding data, encapsulation, or extensions to meet specific needs related to particular industries.

The signature evidence may be embedded directly in the signed document, referred to as an embedded signature, or it may remain separate from the document, referred to as a detached signature.

In many current systems implementing the global document signature process, a graphical representation of the electronic signature may be added to the signature evidence and affixed to a graphical document representing this evidence. This graphical representation of the electronic signature is solely intended to facilitate human interpretation of the signature evidence. However, it has no real probative value unless coupled with actual signature evidence, as described above.

Optionally and advantageously, an electronic signature service may offer a signature verification service. This service allows any person possessing signature evidence, generated through the application of the global electronic document signature process by the signature service, to confirm the validity of the electronic signature of documents related to this evidence. This verification service may, in a non-exhaustive manner, check the document's integrity relative to its state at the time of signing, ensure the non-repudiation of the signatory at the time of signing, or confirm the technical compliance of the electronic signature.

The signature service may perform the global signature process in its entirety or partially. It is also possible for the service to delegate certain parts of the process to third parties. Such delegations are governed by contractual agreements between the signature service and the third party to which a portion of the process is entrusted. It is imperative that these delegations comply with the applicable state-of-the-art standards.

In the context of providing a complete signature service, the provider oversees all necessary and ancillary steps for the proper execution of the document signature process. This operating mode is common in the current electronic document signature ecosystem as it effectively meets the needs of electronic signatures for the general public. In this mode, all information, including documents, is transmitted to the signature service, which supervises the entire global signature process from start to finish.

In the context of providing a partial signature process by a signature service, although the process is executed partially, the signature service remains responsible for ensuring its proper execution (within the limits of state-of-the-art standards). Regarding the aforementioned signature session phase, it is common to integrate this step within an operating application. This integration mode falls within the context of providing a partial signature process by a signature service.

This integration mode enables the embedding of an electronic document signature process within a broader operational framework while entrusting the signature service with the responsibility of ensuring the legal validity of signatures and their compliance with state-of-the-art standards. Applications of this integration approach include, for example, managing contractual aspects with clients or suppliers or handling documents that must be transmitted while preserving the chain of trust, such as electronic invoicing or documents related to internal governance.

This document will hereinafter refer to “integration of the embedded signature session within an operating application.”

In the general context of the global document signature process, an “operating application” is a computing device enabling the integration of a global signature process within a broader operational framework. It is connected to one or more other computing devices or systems via a data communication network, such as the Internet or an intranet. The operating application must be capable of instantiating the signature interface under the conditions contractually stipulated between the signature service operator and the signature service. In particular, the signature service operator must not interfere with the proper execution or modify the content of the signature interface (as defined later in this document) provided by the signature service in any impromptu manner, except for interactions permitted by the signature interface. These interactions are defined in a service contract between these two computing devices. Examples of such interactions include:
Instantiation and de-instantiation of the signature interface from the operating application.
Initialization of a signature session within the signature interface by the operating application.
Interruption of an ongoing signature session within the signature interface by the operating application.
Response to a request initiated from the signature interface to the operating application.

The operating application may take various forms:
It may be a native application executed directly on the operating system of the signature terminal (e.g., a mobile application on a smartphone).
It may be a web application executed within a web browser.
In cases where the signatory is an automated system, it may be a compiled or interpreted computer program executed as a process or subprocess within an operating system.

In the context of the global signature process and generally within the scope of the present invention, the term “signature service operator” refers to the legal entity operating the operating application as described above. Generally, but not exclusively, this is a legal entity seeking to integrate an electronic signature process into an internal process within a broader operational framework.

To enable the signature service to ensure the accuracy of the required steps, thereby consolidating the legitimacy of the signature and compliance with state-of-the-art standards, it is prudent to implement a software module within the operating application that operates controlled by the signature service. The procedures and obligations necessary to comply with established standards are complex, and their application requires specific expertise. It is challenging for an entity that is not a specialist in electronic signatures to meet all the requirements mandated by state-of-the-art standards.

In the context of the global signature process, the term “signature interface” refers to this module. This concept will be further refined later to meet the operational requirements of the invention.

In the context of the present invention, the term “signature terminal” refers to a terminal usable by the approver to execute a document signature session. Depending on the implementation of the global signature process, it may be:
A computing device with a graphical interface, in cases where the approver is an individual or a physical representative of a legal entity. For example, this terminal may be a desktop computer, laptop, tablet, or mobile computing device.
A computing device capable of executing a computer program, in cases where the signatory is an automated computing system. This may include, non-exhaustively, a computer server, virtual machine, or distributed server system.

In all cases, the signature terminal:
May run any operating system.
Must be capable of executing the operating application and the signature interface under the conditions contractually stipulated between the signatory and, respectively, the signature service operator and the signature service.
Must be capable of communicating with the servers operating the signature service (typically via an Internet or intranet connection).

The objective of the present invention is to enable the presentation of the document to be signed within the signature interface in the context of an embedded signature session integrated within an operating application without the need to transmit the document to the server operating the signature service. In doing so, it aims to meet the requirements of state-of-the-art standards, ensuring the legitimacy of the signature while preserving the confidentiality of the document with respect to the signature service.

### SUMMARY

In the context of this description, terms are to be understood in their common technical sense, particularly according to the definitions provided above.

This invention is particularly suited to the use of detached signatures but may also be implemented with embedded signatures.

The invention is a process that fits within the framework of the global signature process as described above. Its primary innovations manifest during the signature session phase while relying on other steps of the global signature process for its overall operation, particularly the initialization phase of the signature request.

The invention is specifically designed to operate in the context of integrating an embedded signature session within an operating application with approvers who are individuals or physical representatives of a legal entity. Adopting this integration mode unlocks essential features that enable the implementation of the invention. One of the key properties thus enabled is the execution of the signature interface, which is controlled by the signature service but “controlled” by the operating application, itself controlled by the signature service operator, on the signature terminal controlled by the approver. This configuration enables the design of workflows that maintain the confidentiality of the document to be signed throughout the signature session while complying with the requirements of state-of-the-art standards.

The invention provides a method for electronically signing a document, comprising the following steps:
[50] Initializing a document signature request by an originator of the signature request and providing a first cryptographic hash value specific to the document to be signed to an electronic signature service.
[100] Requesting initialization, by an operating application, of a signature session to be instantiated within a signature interface.
[200] Providing, by the operating application to the signature interface, elements enabling the initialization of a signature session.
[300] Providing, by the signature service to the signature interface, data related to the initialization of the signature session, including the first cryptographic hash value.
[400] Issuing, by the signature interface to the operating application, a request for the provision of the document to be signed or a URI enabling access to it.
[500] Providing, by the operating application, the data of the document to be signed or the URI enabling access to the document to be signed.
[600] Retrieving, by the signature interface, the data of the document to be signed if the information provided in step [500] is a URI.
[700] Calculating, by the signature interface, a cryptographic hash value of the document to be signed retrieved in step [500] or [600] and comparing, by the signature interface, the first cryptographic hash value with the calculated cryptographic hash value.
[800] Presenting, by the signature interface, the document to be signed to the approver.
Authorizing, by the signature interface, the approver's approval of the document to be signed, provided that the comparison performed in step [700] shows identity between the two cryptographic hash values.

It is thus understood that, in the method according to the invention, the document to be signed is never communicated to the signature service but remains solely between the approver, the signature service operator, and the elements under their control. Although the document is transmitted to the signature interface, which is controlled by the signature service, this signature interface is executed on the signature terminal controlled by the approver. Thus, provided that the signature interface is programmed not to transmit the document to be signed to the signature service, the signature service does not gain knowledge of the document during the signature process. Consequently, complete confidentiality of the document to be signed with respect to the signature service is ensured, coupled with the assurance that the signed document corresponds to the document presented to the signatory and the document intended by the originator during the initialization phase of the signature request.

According to a preferred embodiment of the invention, the method further comprises a step:
• [900], prior to step [1100] and subsequent to step [800], requesting, by the signature interface, authentication elements of the signatory.

In the context of the present invention, the term “authentication elements of the signatory” refers to any authentication means enabling validation that the signatory is indeed the person they claim to be.

According to a preferred embodiment of the invention, the method further comprises a step:
[1000], prior to step [1100] and subsequent to step [800], presenting, by the signature interface, complementary elements to the signature of the document to be signed.

In the context of the present invention, the term “complementary elements to the signature of the document to be signed” refers, in particular, to data distinct from the document to be signed, including, but not limited to, general terms and conditions of sale and forms (e.g., contact forms).

### BRIEF DESCRIPTION OF THE DRAWINGS

FIG. 1 illustrates an example of a method for providing an electronic signature service, in accordance with an embodiment of the present invention.

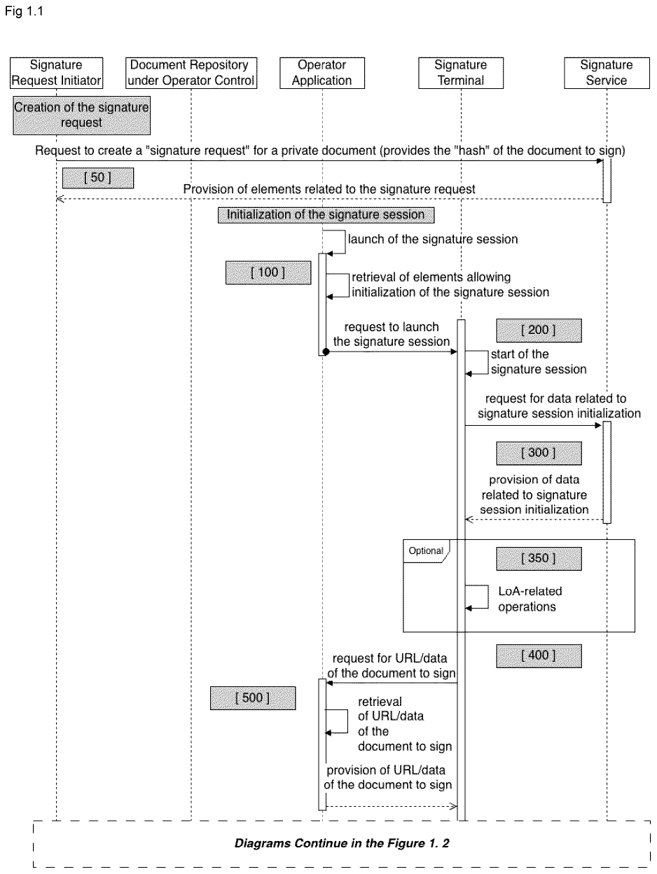

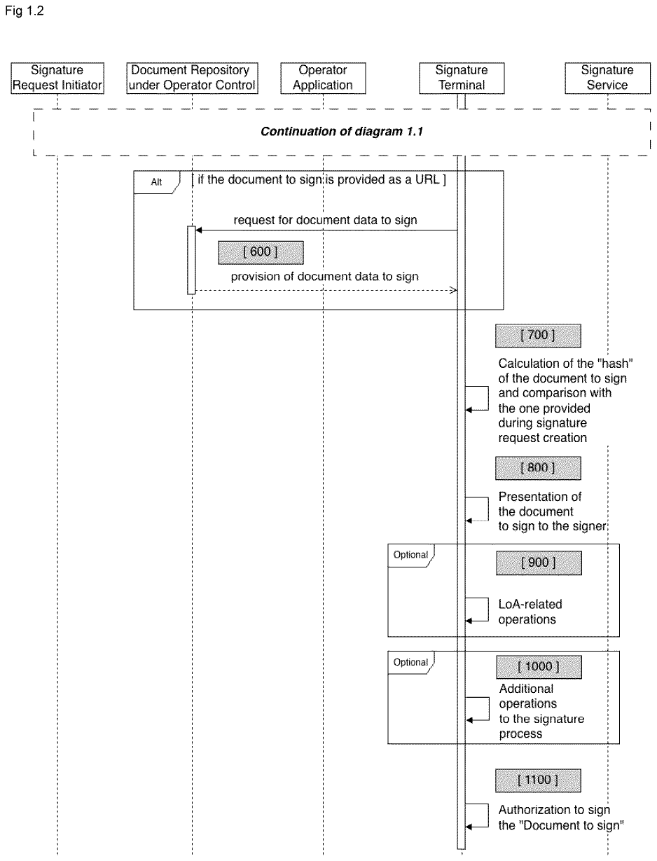

### DETAILED DESCRIPTION

In prior art methods, individuals wishing to use an electronic signature service must disclose the content of the electronic document to the signature service. However, the document may contain confidential information that the user would prefer not to disclose to the electronic signature service.

Advantageously, contractual conditions between the signature service, the signature service operator, and the signatory are established among all parties to comply with the requirements of state-of-the-art standards, thereby ensuring the execution of the signature process under conditions that enable the invention to function as intended by the parties. Among these conditions, the following are particularly noteworthy:
The signatory undertakes to maintain the signature terminal in secure conditions.
The signatory undertakes not to modify either the operating application or the signature interface, when provided on the signature terminal, relative to what was supplied by the signature service operator and the signature service.
The signature service operator undertakes to integrate the signature interface into the operating application in accordance with the requirements notified by the signature service.
The signature service undertakes not to transfer the document subject to the signature from the signature interface to the servers operating the signature service.

The method according to the invention may be implemented by a conventional computing system configured to perform a method according to the invention.

In the context of the invention, the signature terminal is designed to meet the specific obligations of the global signature process as described above, whether for an individual or a legal representative of a legal entity. Thus, this terminal is a computing device equipped with a graphical interface that facilitates user interaction via various input peripherals, such as a keyboard, mouse, touchscreen, or other motion recognition devices. The device must be connected to a computer network, such as the Internet or an internal intranet. The device must be equipped with an operating system enabling low-level interactions with its constituent components and allowing the execution of compiled or interpreted applications by the end user. By way of example, and according to the preferred embodiment of the invention, the terminal may take the form of a desktop computer, laptop, tablet, mobile device, or augmented reality headset. This device will hereinafter be referred to as the “signature terminal in the context of the invention.”

In the context of the invention, the operating application is configured to meet the requirements imposed on it within the framework of a global signature process as described above, whether for an individual or a legal representative of a legal entity. This application may be a native application, executed directly on the terminal's operating system, or a web application executed via an Internet browser. In the latter case, the browser itself is installed as a native application on the signature terminal.

In the context of the invention, native applications are applications designed to be executed directly on the signature terminal's operating system, enabling tight integration with the device's hardware and software resources. They can directly access the operating system's APIs. Native applications support the integration of internal or system-provided libraries, facilitating the addition of advanced functionalities such as cryptography or management of input/output peripherals. These applications may interact with other applications installed on the terminal through mechanisms such as intents on Android or URL schemes on iOS, enabling seamless data exchange between applications.

In the context of the invention, web applications are applications executed within an Internet browser that functions as a native application on the signature terminal. These applications are generally less dependent on the operating system and can be used on various devices without substantial modification. They require an Internet connection to load web resources, although some resources may be stored locally using technologies such as service workers for offline use. Web applications may incorporate components such as iframes to encapsulate other web applications or use JavaScript libraries, either embedded directly in the application or loaded from external servers. This modularity facilitates the addition of functionalities such as interactive user interfaces or connections to external APIs.

According to the preferred embodiment of the invention, the signature interface is designed to meet the requirements of the global signature process, as detailed above. It is integrated into the operating application as an executable component and is specifically programmed not to transmit the document to be signed to an external service during the signature process. This interface may be provided to the operating application in two primary ways:
Dynamic provision: The signature interface is injected into the application at the time of its instantiation. This means the interface can be loaded or updated in real-time from the signature service, providing maximum flexibility and the ability to adapt the interface to the user's specific needs or security requirements at runtime.
Provision during application construction: In this case, the signature interface is integrated as a software library during the development of the operating application. This method ensures that the signature interface is a static component of the software, optimized for security and performance, as it is an integral part of the application from its deployment.

Regardless of the integration mode, the interface is provided by the signature service, which contractually prohibits any modification thereof. According to preferred embodiments of the invention, the integrity of the interface may be ensured by code-signing mechanisms, ensuring that only authentic and verified code is executed. In the case of web applications, the signature interface may be integrated via an iframe mechanism (https://dev.w3.org/html5/spec-LC/the-iframe-element.html#the-iframe-element), which isolates it from the rest of the operating application while facilitating secure integration.

In the context of the invention, it is critical to note that the signature session is executed within the signature interface, which is controlled by the signature service but “controlled” by the operating application, itself controlled by the signature service operator, on the signature terminal controlled by the approver.

Consequently, if a document or data is sent to the signature interface without being transmitted to the servers operating the signature service, this information remains unknown to the signature service. This enables the transmission of a document or data to the signature interface while maintaining the confidentiality of that information with respect to the signature service.

Preferably, the system comprises a server hosting a signature service with at least one memory and one or more processors operatively coupled.

According to a preferred embodiment of the invention, data exchanges between the operating application and the signature service are performed via the HTTP protocol, and more preferably HTTPS.

According to a preferred embodiment of the invention, data exchanges between the signature interface and the signature service are performed via the HTTP protocol, and more preferably HTTPS.
[50] Initializing a document signature request by an originator of the signature request and providing a first cryptographic hash value specific to the document to be signed to an electronic signature service.

When the originator of the signature request provides this first cryptographic hash value, the signature service possesses the means to definitively identify the document to be signed without knowing its content. To provide the first cryptographic hash value, the originator must either possess the document to be signed or have the cryptographic hash value pre-calculated by a third-party service.

Optionally, if the “originator of the signature request” is an external third party relative to the operating application, the elements enabling the initialization of signature sessions from signature requests must be transmitted from the external third party to the operating application to allow the initialization of the signature session. The mode of transmission of these data is at the discretion of the operating application's implementation.

Upon receipt of the request, the signature service authorizes the possibility of initializing a signature session on the signature interface.
[100] Requesting initialization, by an operating application, of a signature session to be instantiated within a signature interface.

This step is performed on the operating application. It involves starting the signature session within a broader operational framework. During this step, the operating application gathers the necessary information within itself to transmit it in the next step (step [200]) to the signature interface to initiate a signature session within said interface.
[200] Providing, by the operating application to the signature interface, elements enabling the initialization of a signature session.

This step involves providing, by the operating application to the signature interface, the elements enabling the initialization of a signature session. Prior to this step, if the operating application has not yet instantiated the signature interface, it is instantiated by the operating application.
[300] Providing, by the signature service to the signature interface, data related to the initialization of the signature session, including the first cryptographic hash value.

This step involves requesting from the server operating the signature service the data necessary to implement the signature process. This data may include, in particular, the signature request identifier and the approver's identification. Other elements, such as authentication or execution context elements, may also be provided. Simultaneously or subsequently to this request, the signature service communicates the first cryptographic hash value to the signature interface. This provision must occur before step [700].
[400] Issuing, by the signature interface to the operating application, a request for the provision of the document to be signed or a URI enabling access to it.

In the context of the present invention, the term URI (Uniform Resource Identifier) refers to a string of characters used to uniquely identify a resource on a computer network. This identification may be by name, location, or both, and enables access to an external resource, such as a file, web service, or database element, via the Internet or an intranet. The URI encompasses URLs (Uniform Resource Locators), which provide concrete resource addresses, and URNs (Uniform Resource Names), which provide unique resource identification independent of location. The use of URIs in the computing process of this invention enables interoperability and efficient communication between different systems and software components.
[500] Providing, by the operating application, the data of the document to be signed or the URI of the document to be signed.

In response to this request, the operating application sends the document to be signed to the signature interface. Alternatively, the operating application sends the URI enabling access to the document to be signed, which can then be downloaded by the signature interface.
[600] Retrieving, by the signature interface, the data of the document to be signed if the information provided in step [500] is a URI.
[700] Calculating, by the signature interface, a cryptographic hash value of the document to be signed retrieved in step [500] or [600] and comparing, by the signature interface, the first cryptographic hash value with the calculated cryptographic hash value.

It is thus understood that if the first and second cryptographic hash values are identical, it means that the document used during the initialization of the signature request (step [50]) and the document to be signed received by the signature interface in step [500] or [600] are strictly identical.
[800] Presenting, by the signature interface, the document to be signed to the approver.

The approver can review the document to be signed on the signature interface.

If the electronic document is encrypted, the display and review of the document occur after its decryption.

The signature interface displays a user interface configured to receive user input to electronically sign the document. This input may be entered via a keyboard or mouse, for example, when the user types their name in an input field displayed in the browser.
Authorizing, by the signature interface, the approver's approval of the document to be signed. This step is characterized in that steps [800] and [1100] are implemented only if the comparison performed in step [700] shows identity between the two cryptographic hash values.

If, after comparing the two cryptographic hash values, it is determined that the cryptographic hash values are different, the signature interface does not authorize the approval of the document to be signed.

Preferably, the signature interface triggers the sending of additional information from the signature interface to the signature service. This information may include, for example, the first and second cryptographic hash values, the cryptographic hash value verification, the current date and time, or other data representing the transaction between the signature interface and the signature service.

According to a preferred embodiment of the invention, step [1000] includes providing instructions executable by the server operating the electronic signature service to the signature terminal, which, when executed in an iframe, enable the secure signing of the document.

1. A method for signing an electronic document, comprising the steps of:
initializing a document signature request by an originator of the signature request and providing, to an electronic signature service, a first cryptographic hash value specific to the document to be signed;
requesting initialization, by an operating application, of a signature session to be instantiated within a signature interface;
providing, by the operating application to the signature interface, elements enabling the initialization of a signature session;
providing, by the signature service to the signature interface, data related to the initialization of the signature session, including the first cryptographic hash value;
issuing, by the signature interface to the operating application, a request for the provision of the document to be signed or a URI enabling access to it;
providing, by the operating application, the data of the document to be signed or the URI enabling access to the document to be signed;
retrieving, by the signature interface, the data of the document to be signed if the information provided in step [500] is a URI;
calculating, by the signature interface, a cryptographic hash value of the document to be signed retrieved in step [500] or [600] and comparing, by the signature interface, the first cryptographic hash value with the calculated cryptographic hash value;
presenting, by the signature interface, the document to be signed to the approver; and
authorizing, by the signature interface, the approver's approval of the document to be signed, provided that the comparison performed in step [700] shows identity between the two cryptographic hash values.

2. The method of claim 1, further comprising a step:
prior to authorizing, requesting, by the signature interface, authentication elements of the signatory.

3. The method of any preceding claim, further comprising a step:
prior authorizing, presenting, by the signature interface, complementary elements to the signature of the document to be signed.

4. The method of claim 1, wherein the signature terminal is a desktop computer, laptop, tablet, mobile device, or augmented reality headset.

5. The method of claim 1, wherein the operating application is a native application or a web application executed via an Internet browser.

6. The method of claim 1, wherein the signature interface is specifically programmed not to transmit the document to be signed to an external service during the signature process.
